(19) United States
(12) Patent Application Publication
(10) Pub. No.: US 2009/0233659 A1
(43) Pub. Date: Sep. 17, 2009

(54) PORTABLE ELECTRONIC DEVICE

(76) Inventors: Po-Jen KE, Taipei City (TW); Hung-Chang Hung, Taipei City (TW); Shiao-Feng Li, Taipei City (TW)

Correspondence Address: Muncy, Geissler, Olds & Lowe, PLLC, P.O. BOX 1364, FAIRFAX, VA, 22038-1364, US

(21) Appl. No.: 12/369,211

(22) Filed: Feb. 11, 2009

(30) Foreign Application Priority Data
Mar. 12, 2008 (TW) 97108662

(51) Int. Cl. H04M 1/00

(52) U.S. Cl. 455/575.3

(57) ABSTRACT

A portable electronic device including a body, an elastic pivot, a sleeve and an upper lid is provided. The body includes a datum plane. The elastic pivot is disposed in the body. The sleeve is disposed on the elastic pivot. The upper lid includes a groove, and the groove includes a first position and a second position. The sleeve enters the groove and slides between the first position and the second position. When the sleeve is in the first position, the upper lid is in a first direction and parallel with the datum plane. When the sleeve is in the second position, the elastic pivot rotates the upper lid to a second direction relative to the datum plane by an elastic force.

### CROSS REFERENCE TO RELATED APPLICATIONS

This application claims the benefit of TW 97108662, filed on Mar. 12, 2008.

### BACKGROUND OF THE INVENTION

1. Field of the Invention

The invention relates to a portable electronic device and, more particularly, to a portable electronic device whose upper lid is rotated automatically with a flick.

2. Description of the Related Art

In a conventional portable electronic device (such as a camera phone or a camera), a pivot with two-step rotation should be disposed between a screen and a body of the portable electronic device to make a display screen face a user, so that the user can preview images in a photographing mode. However, when operating the camera phone or the camera, the user needs to rotate the display by two steps first, which is inconvenient. Fleeting and precious images are often missed, for the user cannot adjust the photographing mode of the camera phone or the camera in time.

### BRIEF SUMMARY OF THE INVENTION

The invention provides a portable electronic device including a body, an elastic pivot, a sleeve and an upper lid. The body includes a datum plane. The elastic pivot is disposed in the body. The sleeve is disposed on the elastic pivot. The upper lid includes a groove, and the groove includes a first position and a second position. The sleeve enters the groove and slides between the first position and the second position. When the sleeve is in the first position, the upper lid is in a first direction and parallel with the datum plane. When the sleeve is in the second position, the elastic pivot rotates the upper lid to a second direction relative to the datum plane by the elastic force.

In the invention, the upper lid can rotate by the elastic pivot automatically. Therefore, the upper lid can be rotated to a predetermined direction conveniently and fast, and the portable electronic device enters into a photographing mode to allow a user to preview an image captured by an image capture assembly through a display and capture a real-time image fast.

### BRIEF DESCRIPTION OF THE DRAWINGS

FIG. 1a is a three-dimensional schematic diagram showing an electronic device whose upper lid is in a second direction in an embodiment of the invention;

FIG. 1b is a three-dimensional schematic diagram showing an electronic device whose upper lid is in a first direction in an embodiment of the invention;

FIG. 2 is a sectional diagram showing a detailed structure of an elastic pivot in an embodiment of the invention;

FIG. 3a is a side view showing an electronic device whose upper lid is in a first direction in an embodiment of the invention;

FIG. 3b is a side view showing an electronic device whose upper lid slides relative to a body in an embodiment of the invention; and

FIG. 3c is a side view showing an electronic device whose upper lid is rotated to a second direction in an embodiment of the invention.

### DETAILED DESCRIPTION OF THE EMBODIMENTS

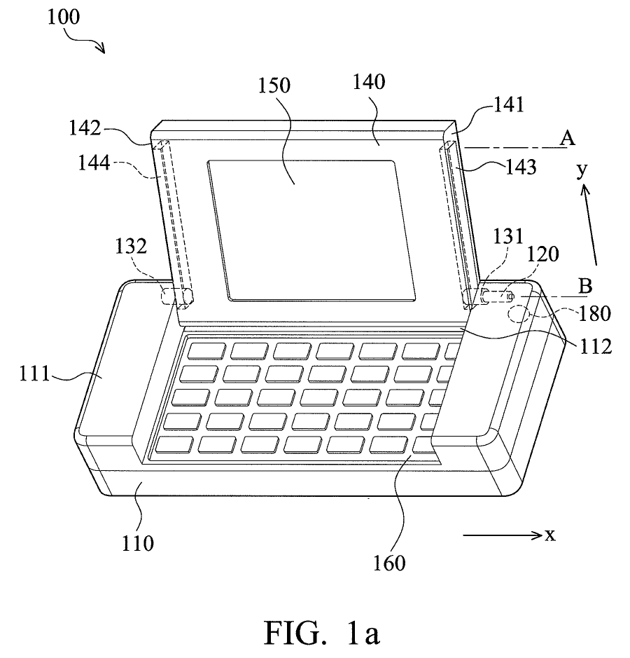

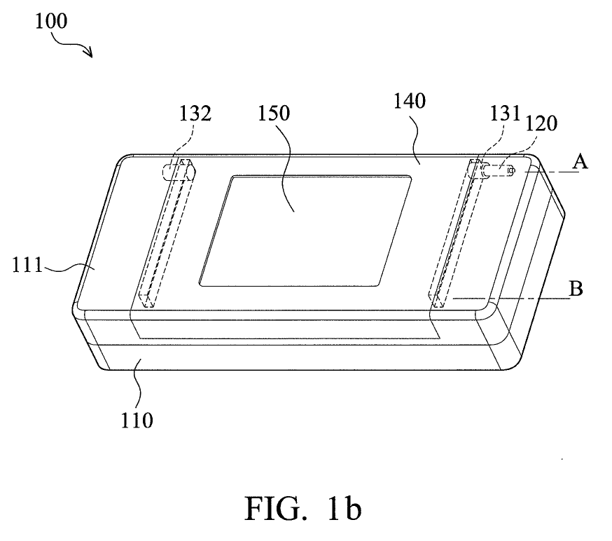

FIG. 1a and FIG. 1b show a portable electronic device 100 in an embodiment of the invention. The portable electronic device 100 includes a body 110, an elastic pivot 120, a first sleeve 131, a second sleeve 132, an upper lid 140, a display 150, an operation interface 160 and an image capture assembly 180. The body 110 includes a datum plane 111 and a notch 112. The elastic pivot 120 is disposed in the body 110. The first sleeve 131 is disposed on the elastic pivot 120. The display 150 is disposed on a surface of the upper lid 140. The operation interface 160 is disposed at the surface of the body 110. The image capture assembly 180 is disposed at the surface of the body 110. The notch 112 is parallel with a major axis x of the body.

The upper lid 140 includes a first side 141, a second side 142, a first groove 143 and a second groove 144. The first groove 143 is located at the first side 141. The second groove 144 is located at the second side 142. The first groove 143 and the second groove 144 include a first position A and a second position B. The first groove 143 and the second groove 144 are parallel with a minor axis y of the upper lid.

The first sleeve 131 enters the first groove 143 and is connected to the upper lid 140 and the elastic pivot 120. The second sleeve 132 enters the second groove 144 and is connected to the upper lid 140 and the body 110.

The first sleeve 131 and the second sleeve 132 slide between the first position A and the second position B. When the first sleeve 131 and the second sleeve 132 are in the first position A, the upper lid 140 is in a first direction (the direction shown in FIG. 1b), parallel with the datum plane 111 and covers the operation interface 160. When the first sleeve 131 and the second sleeve 132 are in the second position B, the elastic pivot 120 rotates the upper lid 140 to a second direction (the direction shown in FIG. 1a) relative to the datum plane 111 by an elastic force.

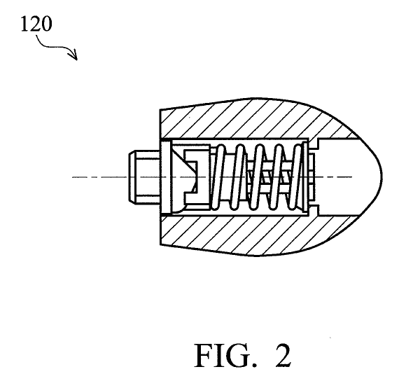

FIG. 2 shows a detailed structure of the elastic pivot 120. In the embodiment of the invention, the elastic pivot 120 may be one of various elastic pivots used in mobile phones or other electronic devices. The structure of the elastic pivot 120 shown in FIG. 2 is not used to limit the scope of the invention.

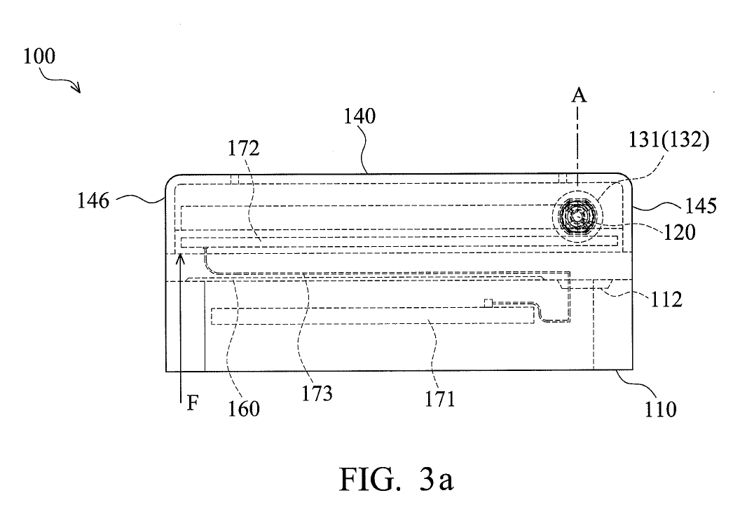

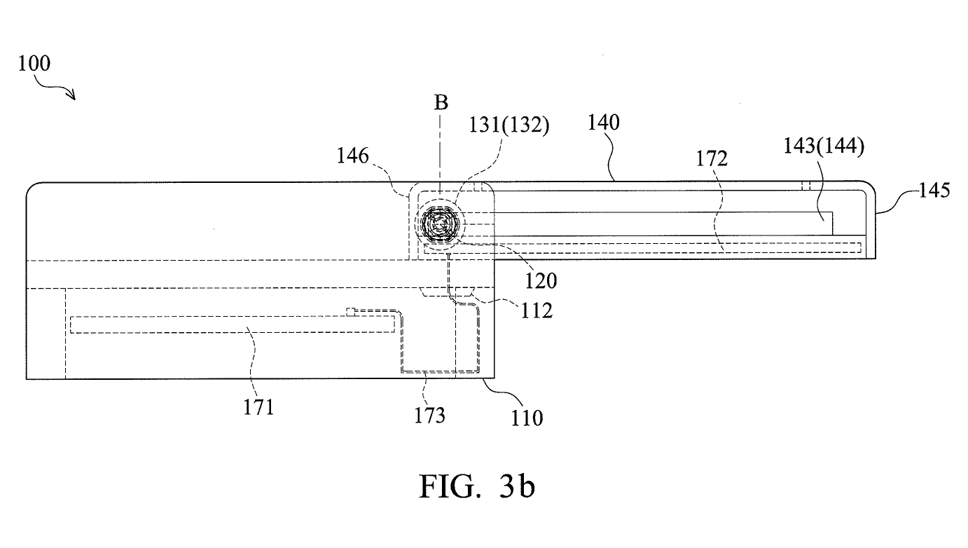

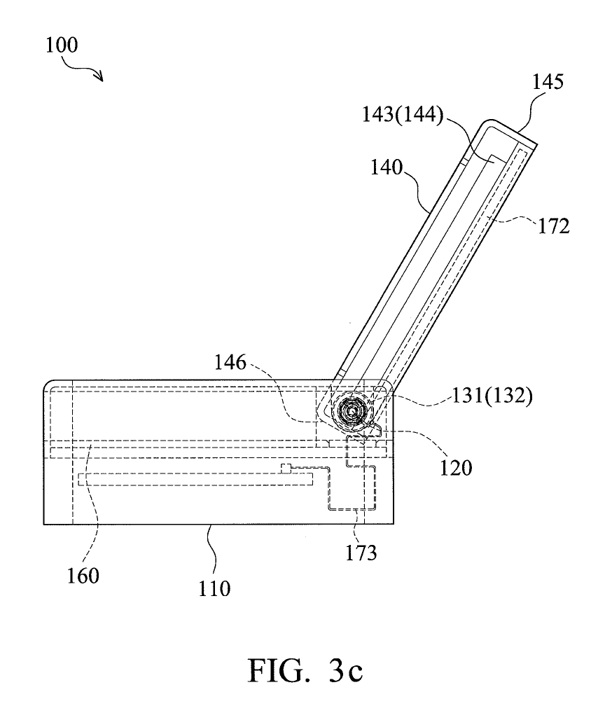

As shown in FIG. 3a, FIG. 3b and FIG. 3c, the upper lid 140 includes a first end 145 and a second end 146. As shown in FIG. 3a, when the first sleeve 131 and the second sleeve 132 are in the first position A, the first sleeve 131 and the second sleeve 132 are close to the first end 145. At that moment, the body 110 touches the second end 146 and provides a supporting force F for the second end 146 to limit the rotation of the elastic pivot 120.

As shown in FIG. 3b, when a user pushes the upper lid 140 to move the first sleeve 131 and the second sleeve 132 to the second position B, the first sleeve 131 and the second sleeve 132 are close to the second end 146. At that moment, the first end 145 is a free end. Then, as shown in FIG. 3c, the elastic pivot 120 rotates the upper lid 140 to the second direction by the elastic force.

As shown in FIG. 3a, FIG. 3b and FIG. 3c, the body 110 further includes a first printed circuit board 171. The upper lid 140 further includes a second printed circuit board 172. A flexible circuit board 173 is connected between the first printed circuit board 171 and the second printed board 172. The flexible circuit board 173 extends out of the body 110 via the notch 112 from the first printed circuit board 171 and enters the upper lid 140 to be connected to the second printed circuit board 172. As shown in FIG. 3a, when the upper lid 140 is in the first direction, the flexible circuit board 173 is laid on the operation interface 160. As shown in FIG. 3c, when the upper lid 140 is in the second direction, the flexible circuit board 173 is accommodated in the body 110.

In the invention, the upper lid can rotate by the elastic pivot automatically. Therefore, the upper lid can be rotated to a predetermined position conveniently and fast, and the portable electronic device enters into a photographing mode to allow the user to preview an image captured by the image capture assembly through the display and capture a real-time image fast.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A portable electronic device comprising:
a body including a datum plane;
an elastic pivot disposed in the body;
a sleeve disposed on the elastic pivot; and
an upper lid including a groove, wherein the groove includes a first position and a second position, and the sleeve enters the groove and slides between the first position and the second position;
wherein when the sleeve is in the first position, the upper lid is in a first direction and parallel with the datum plane, and when the sleeve is in the second position, the elastic pivot rotates the upper lid to a second direction relative to the datum plane.

2. The portable electronic device according to claim 1, wherein the upper lid comprises a first end and a second end, and when the sleeve is in the first position, the sleeve is close to the first end, and the body touches the second end to limit the rotation of the elastic pivot.

3. The portable electronic device according to claim 2, wherein when the sleeve is in the second position, the sleeve is close to the second end, and the first end is a free end.

4. The portable electronic device according to claim 1, further comprising:
an image capture assembly disposed at the surface of the body.

5. The portable electronic device according to claim 1, further comprising:
a flexible circuit board connected to the upper lid and the body.

6. The portable electronic device according to claim 5, wherein the body further comprises a notch and a first printed circuit board, the upper lid further comprises a second printed circuit board, and the flexible circuit board extends out of the body and enters the upper lid to be connected to the second printed circuit board from the first printed circuit board via the notch.

7. The portable electronic device according to claim 6, wherein the notch is parallel with a major axis of the body.

8. The portable electronic device according to claim 1, wherein the body further comprises an operation interface disposed at the surface of the body, and when the upper lid is in the first direction, the upper lid covers the operation interface.

9. The portable electronic device according to claim 8, further comprising:
a flexible circuit board connected to the upper lid and the body, wherein when the upper lid is in the first direction, the flexible circuit board is laid on the operation interface, and when the upper lid is in the second direction, the flexible circuit board is accommodated in the body.

10. The portable electronic device according to claim 1, wherein the groove is parallel with a minor axis of the upper lid.

11. A portable electronic device comprising:
a body including a datum plane;
an elastic pivot disposed in the body;
a first sleeve disposed on the elastic pivot;
a second sleeve; and
an upper lid including a first side, a second side, a first groove and a second groove, wherein the first groove is located at the first side, the second groove is located at the second side, the first groove and the second groove include a first position and a second position, the first sleeve enters the first groove and is connected to the upper lid and the elastic pivot, the second sleeve enters the second groove and is connected to the upper lid and the body, and the first sleeve and the second sleeve slide between the first position and the second position,
wherein when the first sleeve and the second sleeve are in the first position, the upper lid is in a first direction and parallel with the datum plane, and when the first sleeve and the second sleeve are in the second position, the elastic pivot rotates the upper lid to a second direction relative to the datum plane.

12. The portable electronic device according to claim 11, wherein the upper lid comprises a first end and a second end, and when the first sleeve and the second sleeve are in the first position, the first sleeve and the second sleeve are close to the first end, and the body touches the second end and limits the rotation of the elastic pivot.

13. The portable electronic device according to claim 12, wherein when the first sleeve and the second sleeve are in the second position, the first sleeve and the second sleeve are close to the second end, and the first end is a free end.

14. The portable electronic device according to claim 11, further comprising:
an image capture assembly disposed at the surface of the body.

15. The portable electronic device according to claim 11, further comprising:
a flexible circuit board connected to the upper lid and the body.

16. The portable electronic device according to claim 15, wherein the body further comprises a notch and a first printed circuit board, the upper lid further comprises a second printed circuit board, and the flexible circuit board extends out of the body and enters the upper lid to be connected to the second printed circuit board from the first printed circuit board through the notch.

17. The portable electronic device according to claim 16, wherein the notch is parallel with a major axis of the body.

18. The portable electronic device according to claim 11, wherein the body further comprises an operation interface disposed at the surface of the body, and when the upper lid is in the first direction, the upper lid covers the operation interface.

19. The portable electronic device according to claim 18, further comprising:
a flexible circuit board connected to the upper lid and the body, wherein when the upper lid is in the first direction, the flexible circuit board is laid on the operation interface, and when the upper lid is in the second direction, the flexible circuit board is accommodated in the body.

20. The portable electronic device according to claim 11, wherein the first groove and the second groove are parallel with a minor axis of the upper lid.
